(19) United States
(12) Patent Application Publication
(10) Pub. No.: US 2014/0143730 A1
(43) Pub. Date: May 22, 2014

(54) SETTING KEY IMAGE OF ONLINE ALBUM

(71) Applicant: AFOLIO INC., San Francisco, CA (US)

(72) Inventor: She-Rae Chen, San Francisco, CA (US)

(73) Assignee: AFOLIO INC., San Francisco, CA (US)

(21) Appl. No.: 13/684,178

(22) Filed: Nov. 22, 2012

(51) Int. Cl. G06F 3/0482

(52) U.S. Cl. CPC G06F 3/0482
USPC 715/838

(57) ABSTRACT

A method includes, in response to a selection to edit a key image representing an online album administered by a user, displaying a first screen comprising thumbnails of images in the online album. The method includes, in response to a selection of a thumbnail from the thumbnails, displaying a second screen comprising an image corresponding to the selected thumbnail and providing a movable bounding perimeter on the image. The movable bounding perimeter has a fraction of the area of the image. The method includes, in response to a selection of an area on the image with the movable bounding perimeter, saving the selected area as a new key image of the image collection and displaying a third screen comprising the new key image.

### BACKGROUND

Wikipedia describes photo sharing as the publishing or transfer of a user's digital photos online that enables the user to share them with others either publicly or privately. This function is provided through both websites and applications that facilitate the upload and display of images. Photo sharing is not confined to the web and personal computers, but is also possible from portable devices such as cameras and camera phones, using applications that can transfer photos to photo sharing sites.

### BRIEF DESCRIPTION OF THE DRAWINGS

In the drawings:

FIG. 1 is a block diagram of a system for users to share their image, video, audio, text, and other types of media files in one or more examples of the present disclosure;

FIG. 2 is a screenshot of a “my events” screen in one or more examples of the present disclosure;

FIG. 3 is a screenshot of a “single event edit” screen in one or more examples of the present disclosure;

FIG. 4 is a screenshot of a “select cover photo” screen in one or more examples of the present disclosure;

FIG. 5 is a screenshot of a “select key photo” screen in one or more examples of the present disclosure;

FIG. 6 is a screenshot of an updated screen of FIG. 3 with the new key image in one or more examples of the present disclosure;

FIG. 7 is a screenshot of an updated screen of FIG. 2 with the new key image in one or more examples of the present disclosure; and

FIG. 8 is a flowchart of a method to select a key image for an event in one or more examples of the present disclosure.

Use of the same reference numbers in different figures indicates similar or identical elements.

### DETAILED DESCRIPTION OF THE INVENTION

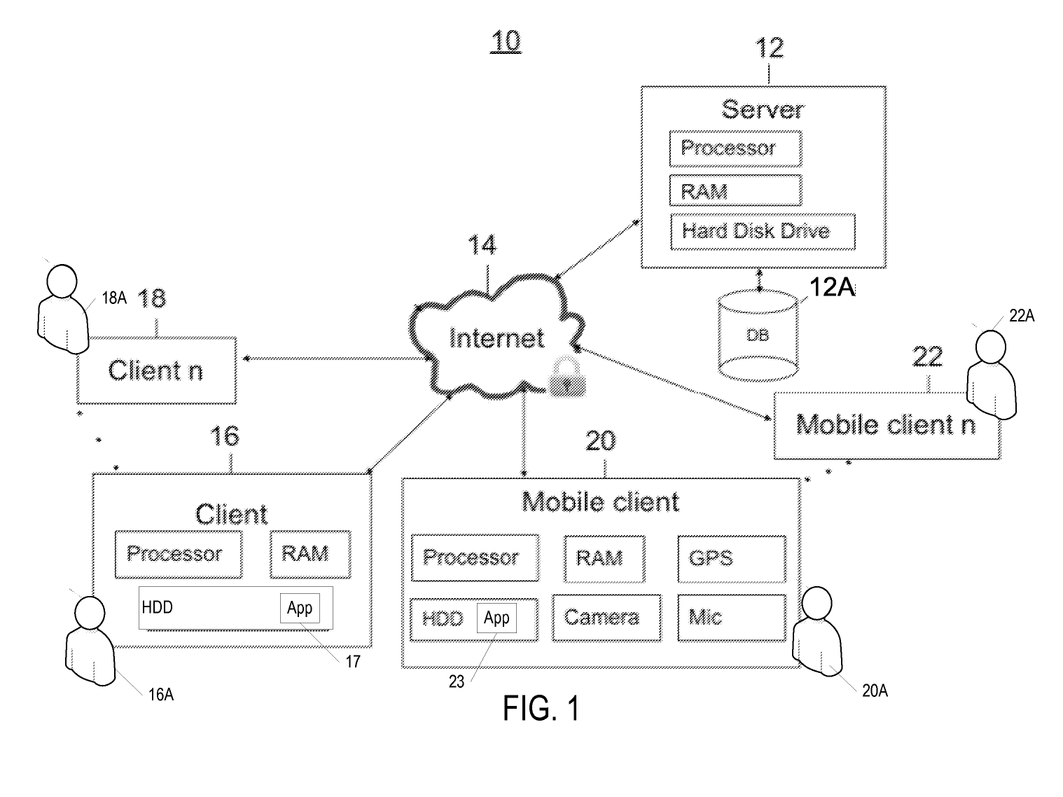

FIG. 1 is a block diagram of a system 10 for users to share their image, video, audio, text, and other types of media files in one or more examples of the present disclosure. The media files may be in any suitable format, including but not limited to JPEG, MP3, MPEG-4, and PDF. Hereafter photos are used to demonstrate system 10 even though the system may be applied to multiple types of media. System 10 includes a server 12 that provides a photo sharing service. Although a single server 12 is illustrated, it may be implemented with multiple physical and virtual servers for load distribution and redundancy. Server 12 includes one or more processors, volatile memory (random access memory), and nonvolatile memory (e.g., hard disk or solid state drive). Server 12 executes one or more applications loaded from nonvolatile memory to volatile memory to implement photo sharing. Server 12 is coupled to a database 12A that stores all the system data, including the photos and their meta data. Although a single database 12A is illustrated, it may be implemented with multiple physical and virtual databases for load distribution and redundancy.

System 10 also includes one or more client devices 16 to 18 and 20 to 22 utilized by users 16A to 18A and 20A to 22A, respectively, to access the photo sharing service provided by server 12. Client devices 16 to 18 may be computers or appliances (e.g., smart television), and client devices 20 to 22 may be mobile phones and tablet devices (e.g., iPhones and iPads). Each client device includes one or more processors, volatile memory, and nonvolatile memory. Client devices 16 to 18 may each run a browser or a desktop client application 17 (only one is labeled) to interact with server 12. Client devices 20 to 22 may each include one or more of a GPS unit, a camera, and a microphone. Client devices 20 to 22 may each run a browser or a mobile client application 23 (only one is labeled) to interact with server 12.

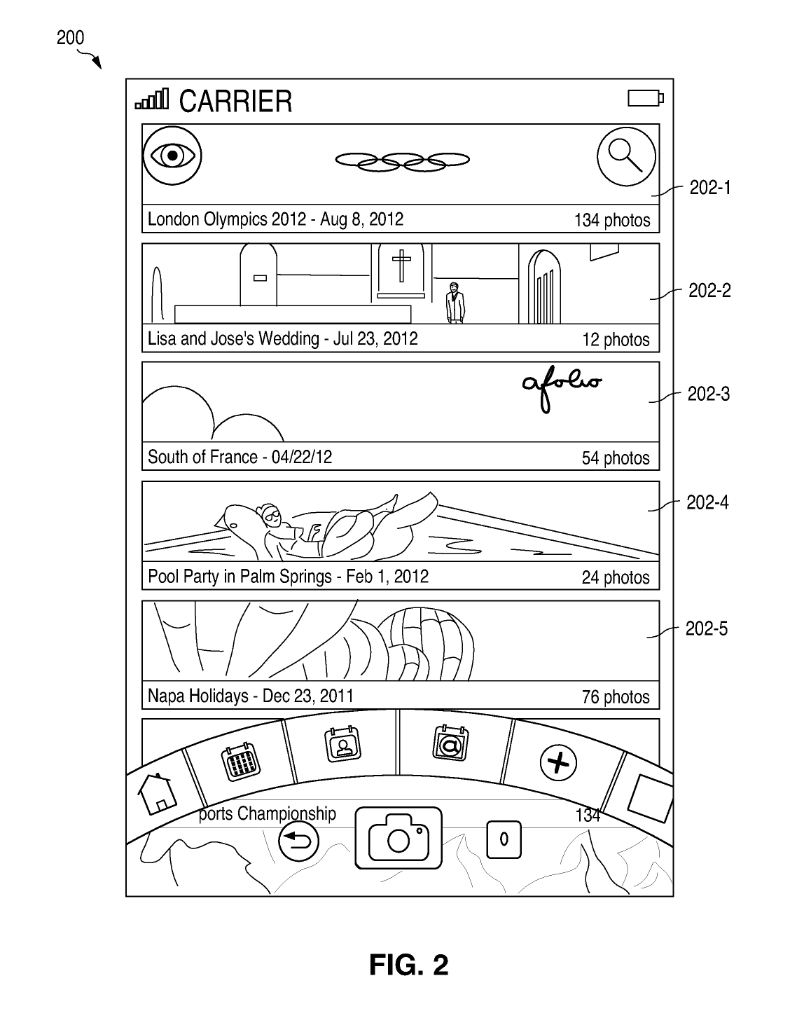

FIG. 2 is a screenshot of a “my events” screen 200 in one or more examples of the present disclosure. Screen 200 includes key images (e.g., photos) 202-1, 202-2, 202-3, 202-4, and 202-5 (hereafter collectively as “key photos 202” or individually as a generic “key photo 202”). Key photos 202 represent respective “events” administered by a user and hosted on server 12 (FIG. 1). An “event” is an online album. In one example, an event allows users at an event (e.g., a party, a wedding, a ski vacation) to collectively upload photos taken at the event for sharing with each other. For example, the user may create an event for her wedding where all the guests at the wedding may upload photos taken at the wedding for sharing with each other.

On screen 200, key photos 202 are arranged in a single column. A key photo 202 is a slice of a photo from a corresponding event. In one example, key photo 202 is a rectangular slice of a photo. A photo has a standard aspect ratio, such as 16:9, 4:3, 3:2, or 1:1. A key photo 202 can have an aspect ratio greater than 16:9, such as 64:13. The size and shape of key photo 202 allows a number of key photos 202 to be stacked on a small screen, such as those on client devices 20 to 22 (FIG. 1). In other examples, key photo 202 is a slice of a different geometric shape, such as triangle, that allows key photos 202 to be efficiently displayed on a small screen.

In one example, server 12 automatically selects a key photo 202 for a newly created event. Server 12 selects the first or the last uploaded photo to the event, divides the selected photo into thirds with two horizontal lines, and then takes a slice centered about the top horizontal line on the selected photo as key photo 202. Alternatively server 12 takes a slice about an area with pixel values having skins tones. As the administrator of the events, the user has the right to edit key photos 202.

The user may scroll screen 200 to view any additional key images. The user may select an event by selecting a corresponding key photo 202 on screen 200. In response, a “single event view” screen is presented and the user may elect to edit an event by selecting an edit event button.

Note that screen 200 may also represent an “all events” screen in one or more embodiments of the present disclosure. All events screen 200 displays key images 202 of events that the user is a member of. The user is an event member when he or she is invited to a private event or joins a public event.

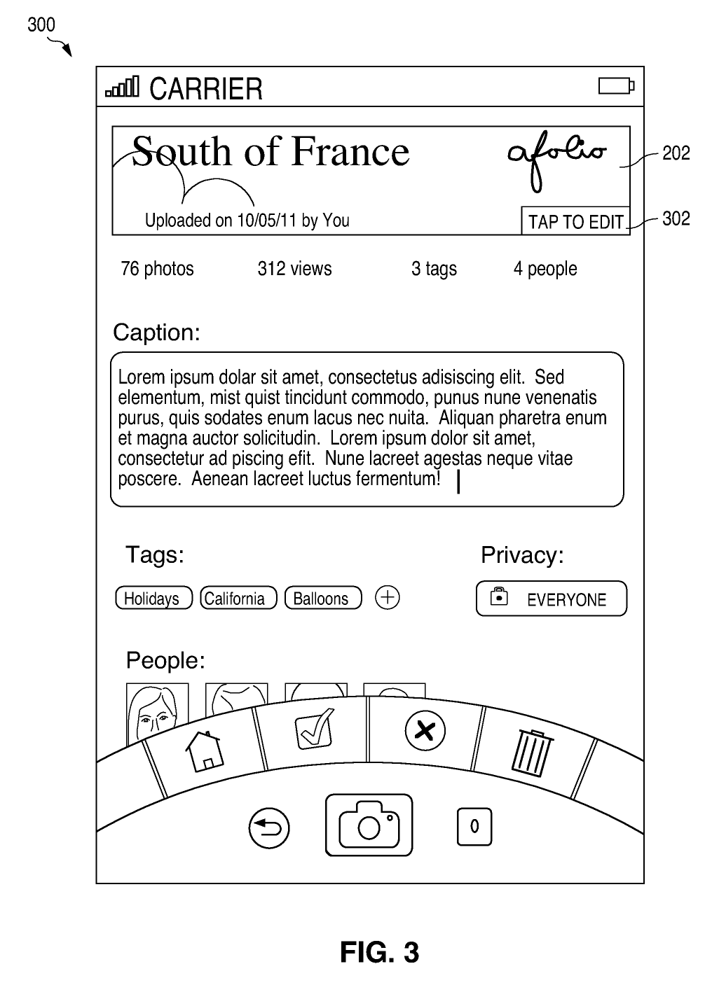

FIG. 3 is a screenshot of a “single event edit” screen 300 in one or more examples of the present disclosure. Screen 300 includes a key photo 202 and other editable information about the event, such as a caption, tags, event members, and a privacy setting. The user may elect to edit key photo 202 by selecting a button 302 or the key photo 202 itself.

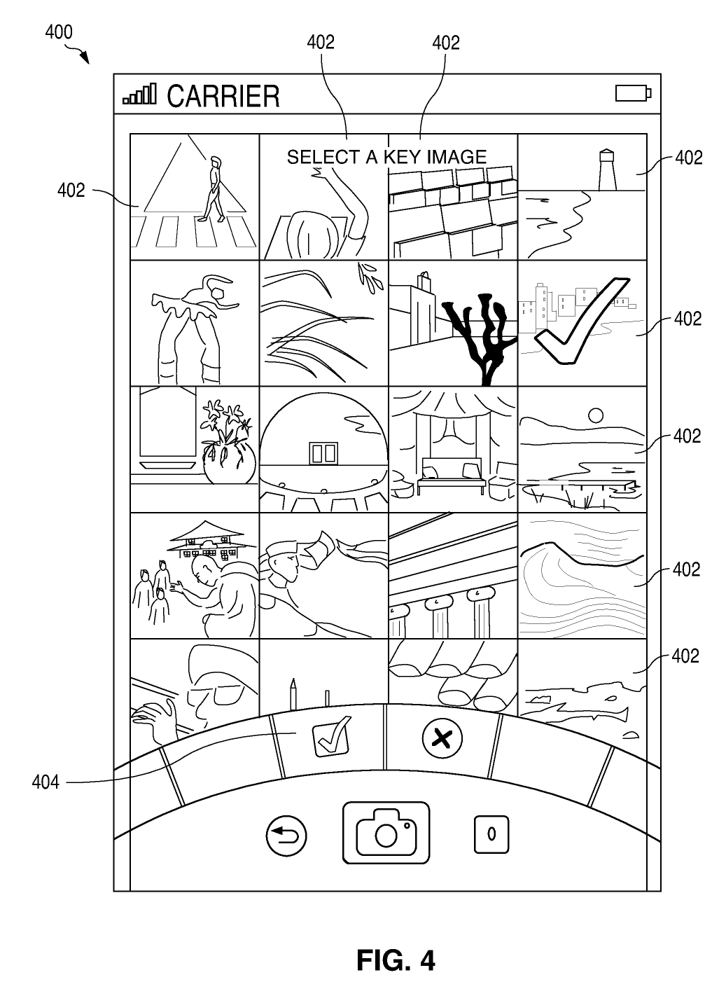

FIG. 4 is a screenshot of a “select cover photo” screen 400 in one or more examples of the present disclosure. A “cover photo” is a photo in the selected event from which a slice is taken to generate a key photo 202. Screen 400 includes thumbnails 402 (only a selected few are labeled) of the photos in the selected event. The user may pick a cover photo by selecting a thumbnail 402 and then selecting a confirmation button 404.

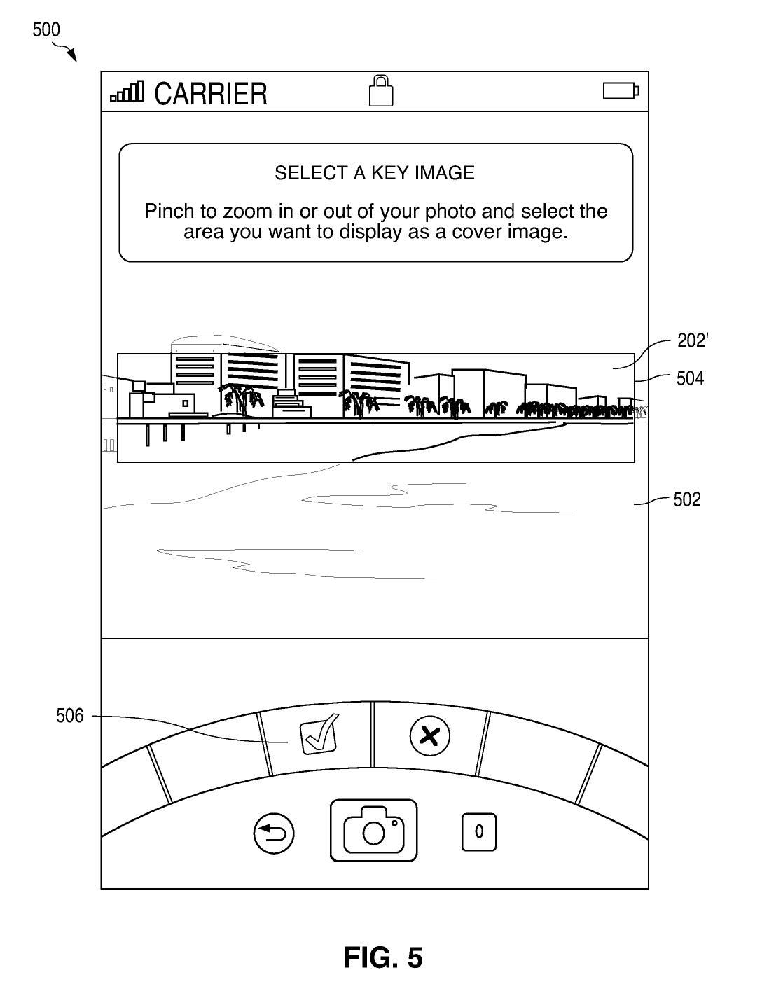

FIG. 5 is a screenshot of a “select key photo” screen 500 in one or more examples of the present disclosure. Screen 500 includes a selected cover photo 502. The user may zoom in and out of cover photo 502. Screen 500 also includes a movable bounding parameter 504. In one example, bounding perimeter 504 has one third (⅓) or less of the area of cover photo 502. In one example, bounding parameter 504 is a bounding box having the aspect ratio of key photo 202 (FIGS. 2 and 3). In one example, the aspect ratio of bounding box 504 and key photo 202 is fixed. Alternatively the aspect ratio is editable. To pick a new key photo 202′, the user moves bounding box 504 to a desirable location and then selects a confirmation button 506.

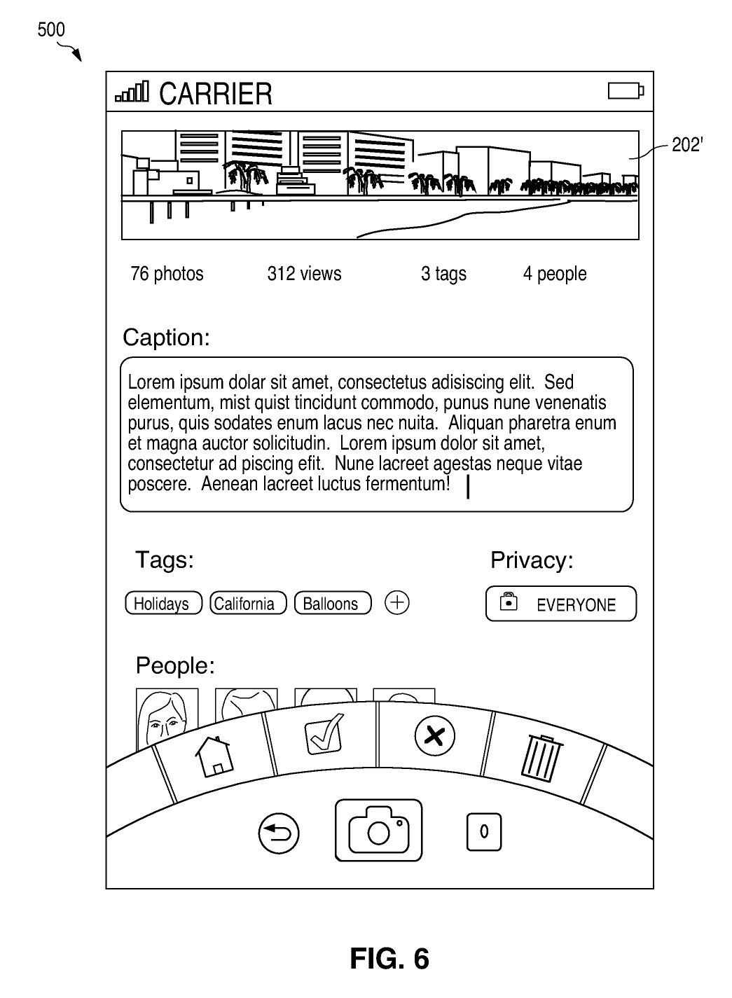

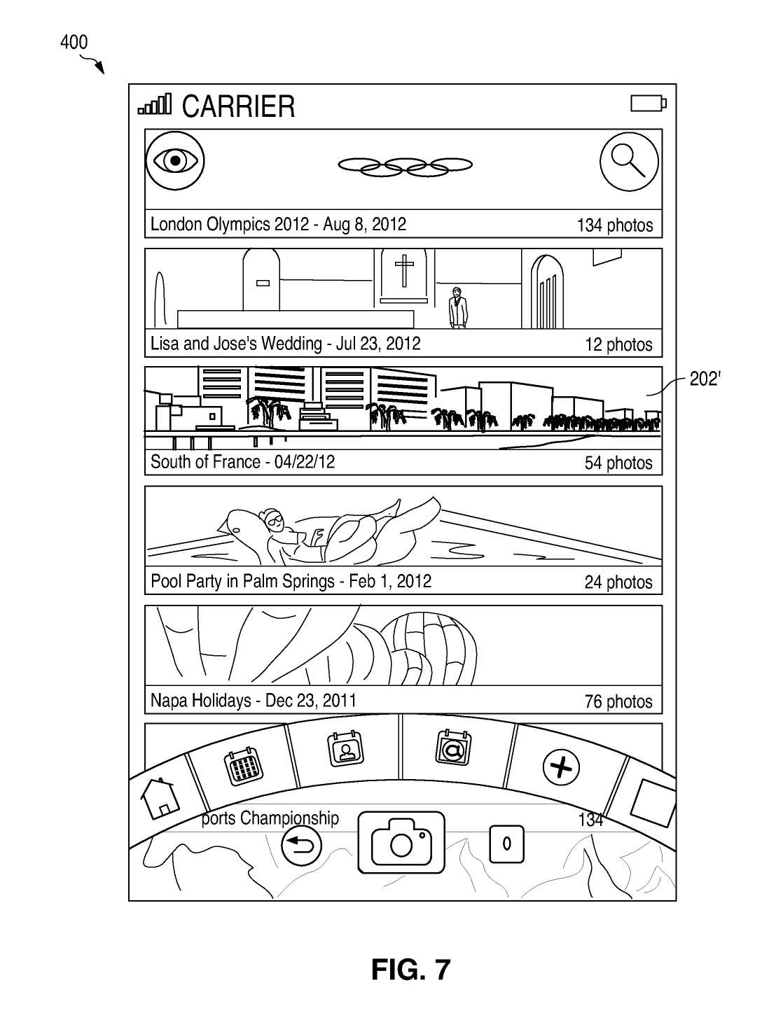

FIG. 6 is a screenshot of an updated screen 500 with the new key photo 202′ in one or more examples of the present disclosure. FIG. 7 is a screenshot of an updated screen 400 with the new key photo 202′ in one or more examples of the present disclosure.

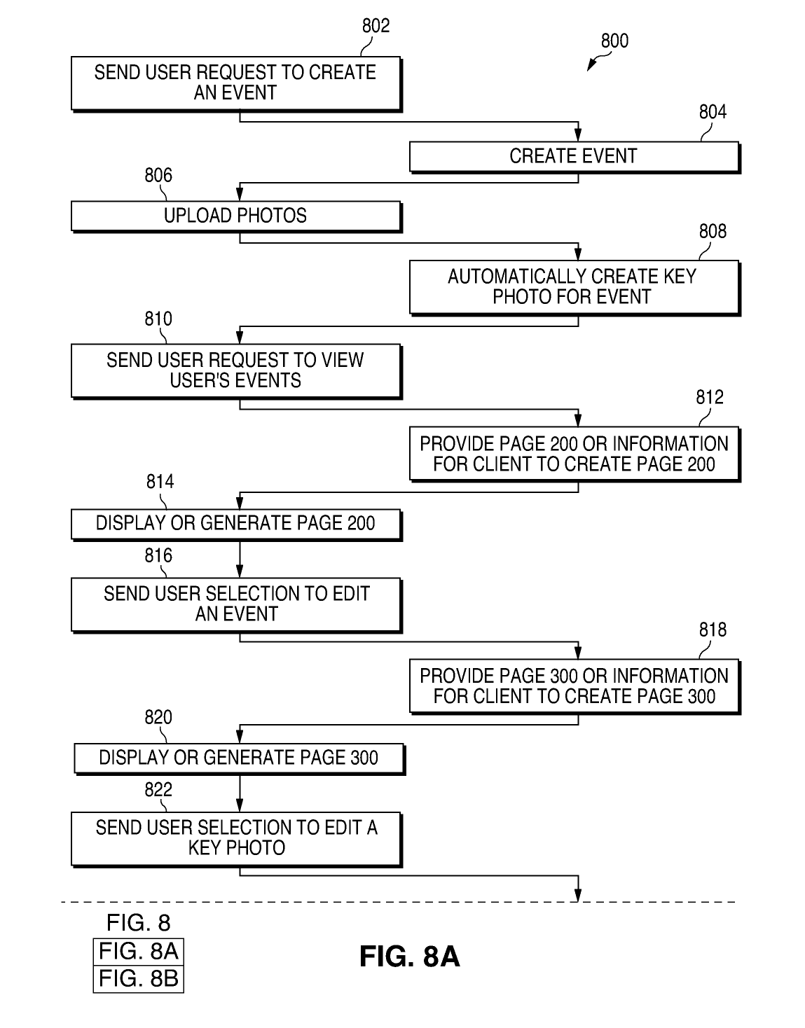

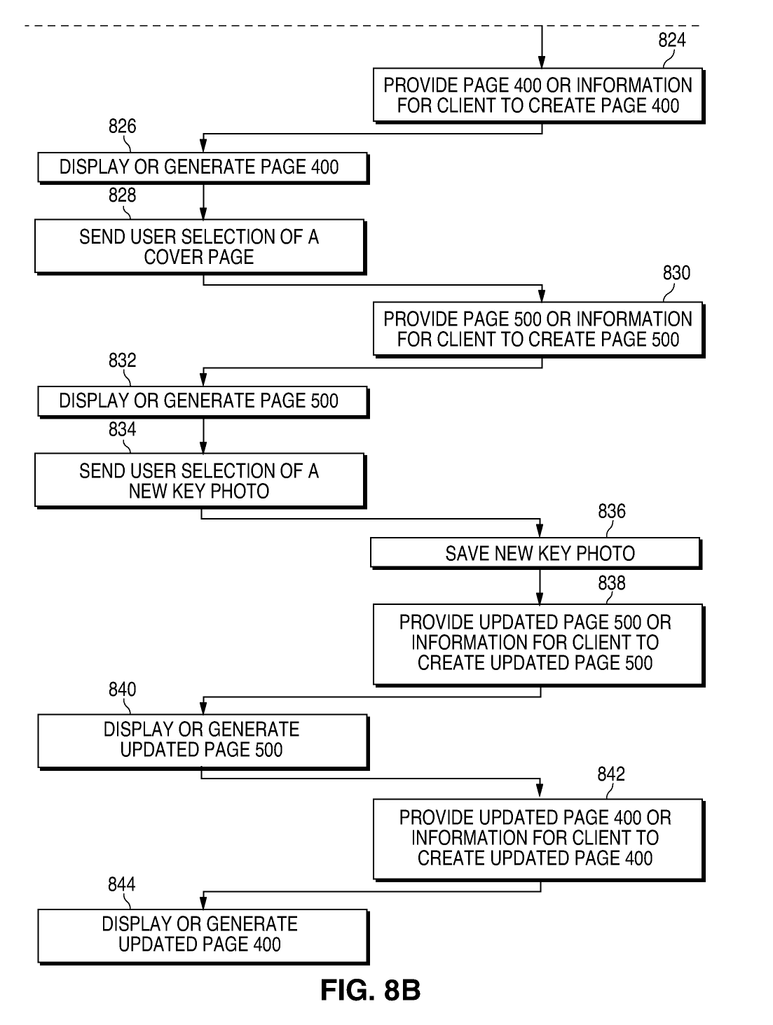

FIG. 8 is a flowchart of a method 800 to implement a method to select a key image for an event in one or more examples of the present disclosure. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 800 may begin in block 802.

In block 802, a client device (e.g., client device 20 in FIG. 1) sends a user request to create an event over network 14 (FIG. 1) to server 12 (FIG. 1). Block 802 may be followed by block 804.

In block 804, server 12 creates the event administered by the user in response to the user request of block 802. Block 804 may be followed by block 806.

In block 806, client device 20 uploads photos to the event. Other users may also upload photos to the event. Block 806 may be followed block 808.

In block 808, server 12 automatically creates a key photo 202 (FIG. 2) for the event. As described above, server 12 automatically selects a photo from the photos in the event and automatically saves a slice of the selected photo as key photo 202 representing the event. As described above, the slice has one third (⅓) or less of the area of the selected photo. Block 808 may be followed by block 810.

In block 810, client device 20 sends a user request to view the user's events over network 14 to server 12. Block 810 may be followed by block 812.

In block 812, server 12 transmits my events screen 200 (FIG. 2) for a browser 23 (FIG. 2) or the information necessary for a mobile client application 23 to generate screen 200 over network 14 to client device 20 in response to the user request of block 810. Block 812 may be followed by block 814.

In block 814, client device 20 displays screen 200. Block 814 may be followed block 816.

In block 816, client device 20 sends a user selection to edit an event on screen 200 over network 14 to server 12. Block 816 may be followed by block 818.

In block 818, server 12 transmits singe event edit screen 300 (FIG. 3) for a browser 23 or the information necessary for a mobile client application 23 to generate screen 300 over network 14 to client device 20 in response to the user request of block 816. Block 818 may be followed by block 820.

In block 820, client device 20 displays screen 300. Block 820 may be followed by block 822.

In block 822, client device 20 sends a user selection to edit a key photo 202 of the event to server 12 over network 14. Block 822 may be followed by block 824.

In block 824, server 12 transmits select cover photo screen 400 (FIG. 4) for a browser 23 or the information necessary for a mobile client application 23 to generate screen 400 (e.g., the thumbnails of the images in the event) over network 14 to client device 20 in response to the user request of block 822. Block 824 may be followed by block 826.

In block 826, client device 20 displays screen 400. Block 826 may be followed block 828.

In block 828, client device 20 sends a user selection of a cover photo 502 (FIG. 5) over network 14 to server 12. Block 828 may be followed by block 830.

In block 830, server 12 transmits select key photo screen 500 (FIG. 5) for a browser 23 or the information necessary for a mobile client application 23 to generate screen 500 over network 14 to client device 20 in response to the user selection of block 828. Block 830 may be followed by block 832.

In block 832, client device 20 displays screen 500. Block 832 may be followed by block 834.

In block 834, client device 20 sends a user selection of an area on cover photo 502 to be a new key photo 202′ (FIG. 5) to server 12 over network 14. The selection of the area on cover photo 502 is sent as the X and Y coordinates of the four corner pixels of bounding box 504 (FIG. 5) as percentages of the width and the height of cover photo 502 so key image 202′ can be resized correctly on different screen sizes. Alternatively client device 20 sends a new key photo 202′ generated from cover photo 502 to server 12 over network 14. Block 834 may be followed by block 836.

In block 836, saves the selection of the area on cover photo 502 for generating key photo 202′ later. Alternatively server 12 saves key photo 202′ for the event. Block 836 may be followed by block 838.

In block 838, server 12 transmits an updated screen 500 (FIG. 6) for a browser 23 or the information necessary for a mobile client application 23 to generate the updated screen 500 over network 14 to client device 20. Block 838 may be followed by block 840.

In block 840, client device 20 displays the updated screen 500 with the new key photo 202′. Block 840 may be followed by block 842.

In block 842, server 12 transmits an updated screen 400 (FIG. 7) for a browser 23 or the information necessary for a mobile client application 23 to generate the updated screen 400 over network 14 to client device 20. Block 842 may be followed by block 844.

In block 844, client device 20 displays the updated screen 400 with the new key photo 202′.

Various other adaptations and combinations of features of the embodiments disclosed are within the scope of the invention. Numerous embodiments are encompassed by the following claims.

1. A method, comprising:
in response to a selection to edit a key image representing an online album administered by a user, displaying a first screen comprising thumbnails of images in the online album;
in response to a selection of a thumbnail from the thumbnails:
displaying a second screen comprising an image corresponding to the selected thumbnail; and
providing a movable bounding perimeter on the image, the movable bounding perimeter having a fraction of the area of the image;
in response to a selection of an area on the image with the movable bounding perimeter:
saving the selection of the area on the image for generating a new key image for the online album or saving the selected area as the new key image for the online album; and
displaying a third screen comprising the new key image.

2. The method of claim 1, wherein the third screen provides a user interface for editing information about the online album.

3. The method of claim 2, further comprising displaying a fourth screen comprising the new key image and other key images representing other online albums administered by the user.

4. The method of claim 3, wherein the key image and the other key images are arranged in a column.

5. The method of claim 3, wherein each online album comprises respective images from an event with a group of people.

6. The method of claim 1, wherein each key image comprises a rectangular slice of a corresponding image, the rectangular slice having an aspect ratio of 64:13.

7. The method of claim 1, wherein an aspect ratio of the movable bounding perimeter is fixed or editable.

8. The method of claim 1, wherein the selection of the area on the image comprises X and Y coordinates of the four corner pixels of the movable bounding perimeter as percentages of a width and a height of the image.

9. A method, comprising:
receiving images for an online album administered by a user;
automatically selecting an image from the images;
automatically saving a slice of the image as a key image presenting the online album, the slice having a fraction of the area of the image; and
displaying the key image or transmitting the key image over a computer network.

10. The method of claim 9, wherein automatically selecting an image from the images comprising selecting a first received image for the online album.

11. The method of claim 9, wherein the slice is centered about one of the two horizontal lines that divides the image into thirds.

12. The method of claim 9, further comprising:
receiving a request to edit the key image;
providing a plurality of thumbnails of the images;
receiving a selection of a thumbnail from the thumbnails;
providing another image that corresponds to the selected thumbnail;
receiving a selection of another slice of the other image; and
saving the selection of the other slice for generating a new key image for the online album or the selected slice as the new key image for the online album.

13. The method of claim 12, further comprising displaying the new key image or transmitting the new key image over the computer network.

14. The method of claim 13, further comprising displaying the new key image and other key images presenting other online albums administered by the user or transmitting the new key image and the other key images over the computer network.

15. The method of claim 14, wherein each online album comprises respective images from an event with a group of people.

16. The method of claim 14, wherein each key image comprises a rectangular slice of a corresponding image, the rectangular slice having an aspect ratio of 64:13.

17. The method of claim 12, wherein the selection of the area on the image comprises X and Y coordinates of the four corner pixels of the movable bounding perimeter as percentages of a width and a height of the image.

18. A method, comprising:
displaying a screen with key images stacked in a vertical column, the key images representing respective online albums, wherein each key image is a slice of an image from a respective online album.

19. The method of claim 18, further comprising, in response to a selection of a key image, displaying another screen for a corresponding online album.

20. The method of claim 18, wherein the online albums are administered by a same user.
